(19) United States
(12) Patent Application Publication
(10) Pub. No.: US 2010/0170644 A1
(43) Pub. Date: Jul. 8, 2010

(54) Decorative valance structure

(75) Inventor: Scott Kohl, Kent, OH (US)

Correspondence Address: James A. Hudak, Esq., 29425 Chagrin Blvd., Suite # 304, Cleveland, OH, 44122, US

(73) Assignee: Astra Products Ltd.

(21) Appl. No.: 12/319,245

(22) Filed: Jan. 6, 2009

(51) Int. Cl. E06B 9/26

(52) U.S. Cl. 160/166.1

(57) ABSTRACT

A decorative valance structure for a vertical blind assembly is disclosed. The longitudinally extending portion and the return portions of the valance structure are cut to the desired length from a PVC extrusion. Corner members are utilized to join the opposite ends of the longitudinally extending portions to the return portions. A flexible extrusion is attached to the top edge and the bottom edge of the valance structure and a section of vertical blind material is received between the flexible extrusions so as to cover the valance structure. The vertical blind material utilized to cover the valance structure “matches” the material for the vertical blind assembly providing a decorative appearance to the valance structure.

### TECHNICAL FIELD

The present invention relates, in general, to a valance for a vertical blind assembly and, more particularly, to a vertical blind valance structure that is decorative in appearance and utilizes a minimum number of parts or components.

### BACKGROUND ART

Valances are used in many instances to conceal the carrier assembly and actuating mechanism for vertical blind installations. These valances typically utilize a number of parts or components which make the assembling of same and installation of the valance a rather time consuming task. In addition, the valances in many instances are not decorative in nature and do not “match” the vertical blinds in appearance. Thus, the valances are not pleasing to the eye.

In view of the foregoing disadvantages associated with presently available valance structures, it has become desirable to develop a valance structure which utilizes a minimum number of parts or components and which is decorative in appearance so as to be pleasing to the viewer.

### SUMMARY OF THE INVENTION

The present invention solves the problems associated with presently available valances for vertical blind installations and other problems by providing a valance structure that utilizes a minimum of parts or components and which is decorative in appearance. The longitudinally extending portion and the return portions of the valance structure are cut to the desired length from a PVC extrusion. Corner members are utilized to join the opposite ends of the longitudinally extending portion with the return portions. A flexible extrusion is attached to the top edge and to the bottom edge of the longitudinally extending portion, the return portions and the corner members. A section of vertical blind material is received between the flexible extrusions so as to cover the longitudinally extending portion, the return portions and the corner members. The vertical blind material utilized to cover the valance structure “matches” the material utilized for the vertical blinds providing a decorative appearance to the valance structure.

### BRIEF DESCRIPTION OF THE DRAWINGS

FIG. 1 is a perspective view of a vertical blind assembly utilizing the decorative valance structure of the present invention.

FIG. 2 is a partial rear perspective view of the decorative valance structure of the present invention.

FIG. 3 is a partial top plan view of the decorative valance structure of the present invention.

FIG. 4 is a cross-sectional view of the decorative valance structure of the present invention taken across section-indicating lines 4-4 in FIG. 3.

FIG. 5 is a partial cross-sectional view of the extrusion forming the longitudinally extending portion and the return portions of the valance structure and the flexible extrusion that is attached thereto and illustrates the flexible extrusion retaining a section of vertical blind material against the extrusion forming the longitudinally extending portion and the return portions.

FIG. 6 is a cross-sectional view of the extrusion that is utilized to form the longitudinally extending portion and the return portions of the decorative valance structure of the present invention.

FIG. 7 is a cross-sectional view of the flexible extrusion utilized by the decorative valance structure of the present invention.

FIG. 8 is a perspective view of the corner member utilized by the decorative valance structure of the present invention.

### DESCRIPTION OF THE PREFERRED EMBODIMENT

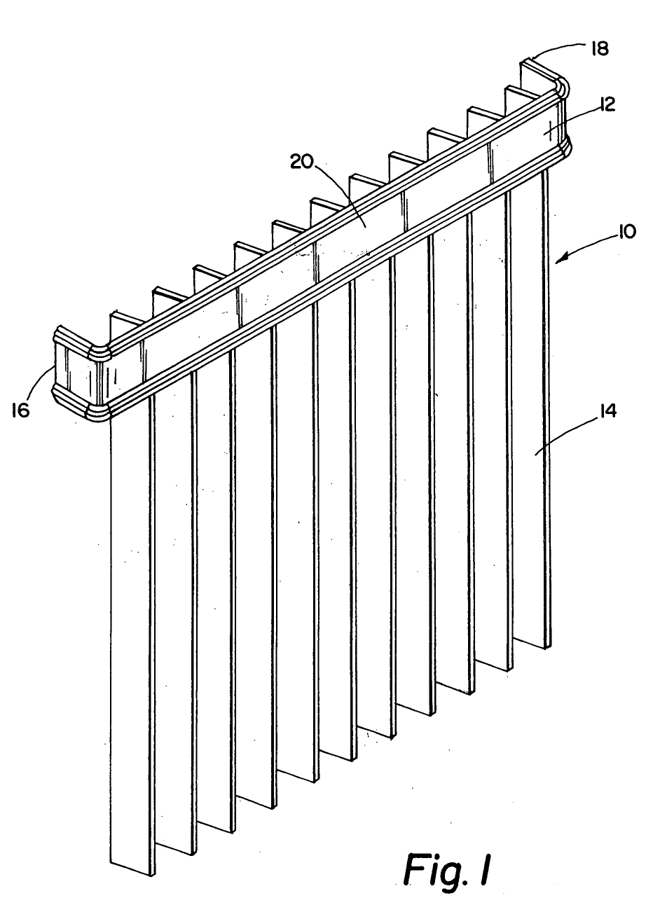

Referring now to the drawings, FIG. 1 is a perspective view of a vertical blind assembly 10 utilizing the decorative valance structure 12 of the present invention. The vertical blind assembly 10 is comprised of a plurality of blind members 14 hanging in a vertical orientation and in a spaced-apart relationship. The top of each blind member 14 is attached to a longitudinally extending horizontal carrier arrangement (not shown). The longitudinally extending horizontal carrier arrangement includes an actuating mechanism permitting the blind members 14 to be simultaneously rotated to open and/or close an opening, such as a window or door, which they are covering. The decorative valance structure 12 of the present invention is mounted at its oppositely disposed ends 16, 18 to the wall or surface surrounding the window or door to be covered and is utilized to conceal the longitudinally extending horizontal carrier arrangement and its associated actuating mechanism. A section 20 of blind material, which matches the material utilized for the blind members 14, is received within the valance structure 12 to provide a “decorative touch” to the vertical blind assembly 10.

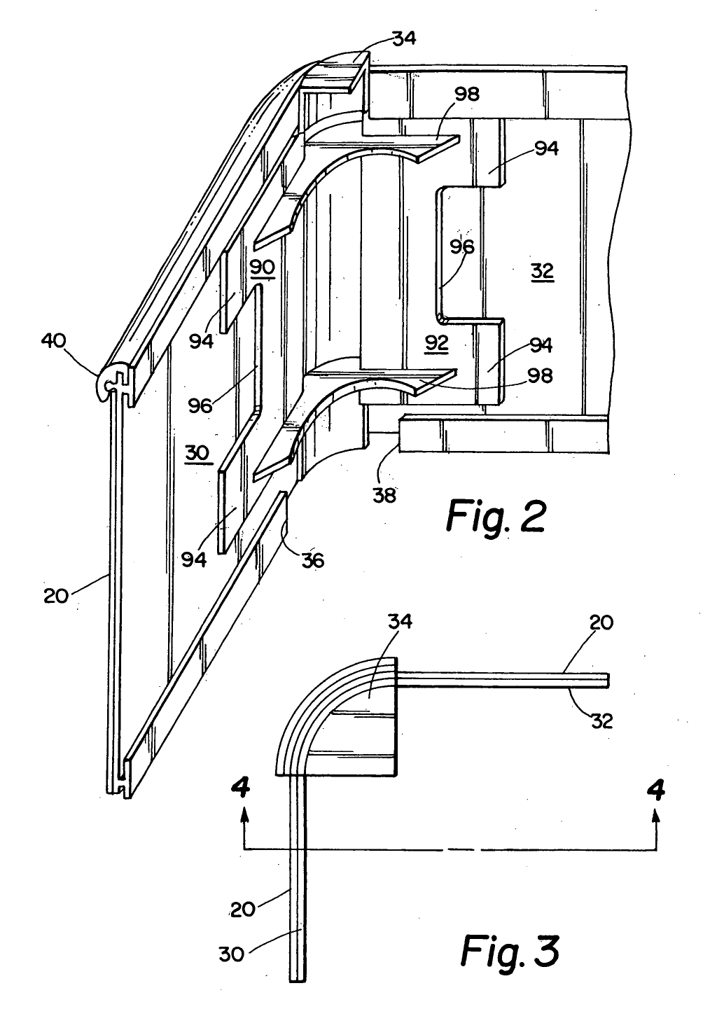

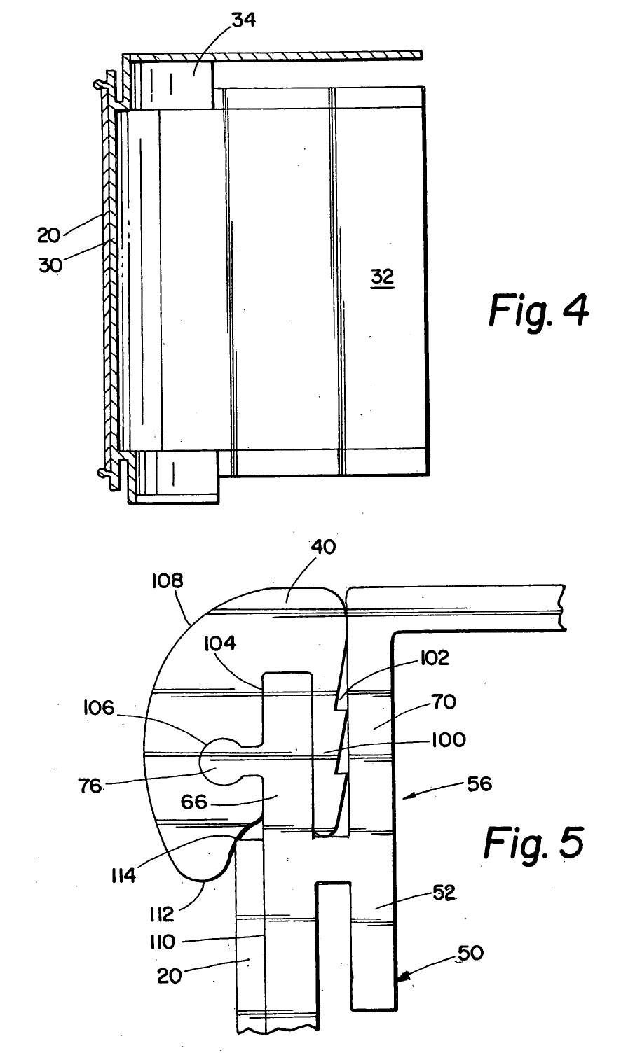

Referring now to FIG. 2, a partial rear perspective view of the decorative valance structure 12 of the present invention is illustrated and shows the longitudinally extending portion thereof, shown generally by the numeral 30, a return portion thereof, shown generally by the numeral 32, and a corner member, shown generally by the numeral 34. When installed over the longitudinally extending carrier arrangement and its associated actuating mechanism for the vertical blind assembly 10, the longitudinally extending portion 30 of the decorative valance structure 12 is positioned over the longitudinally extending carrier arrangement and its associated actuating mechanism so as to conceal same, the return portion 32 of the decorative valance structure 12 is positioned over the return portion of the longitudinally extending carrier arrangement to conceal same, and the corner member 34 joins end 36 of the longitudinally extending portion 30 of the decorative valance structure 12 to end 38 of the return portion 32 of the decorative valance structure 12. The longitudinally extending portion 30 and the return portion 32 of the decorative valance structure 12 are formed from an extrusion, hereinafter described. A section 20 of blind material is placed against the outer surfaces of the longitudinally extending portion 30, the return portion 32 and the corner member 34 of the decorative valance structure 12 and is held in place by an elongated flexible extrusion 40 which is positioned along the top and bottom of the overall length of the decorative valance structure 12.

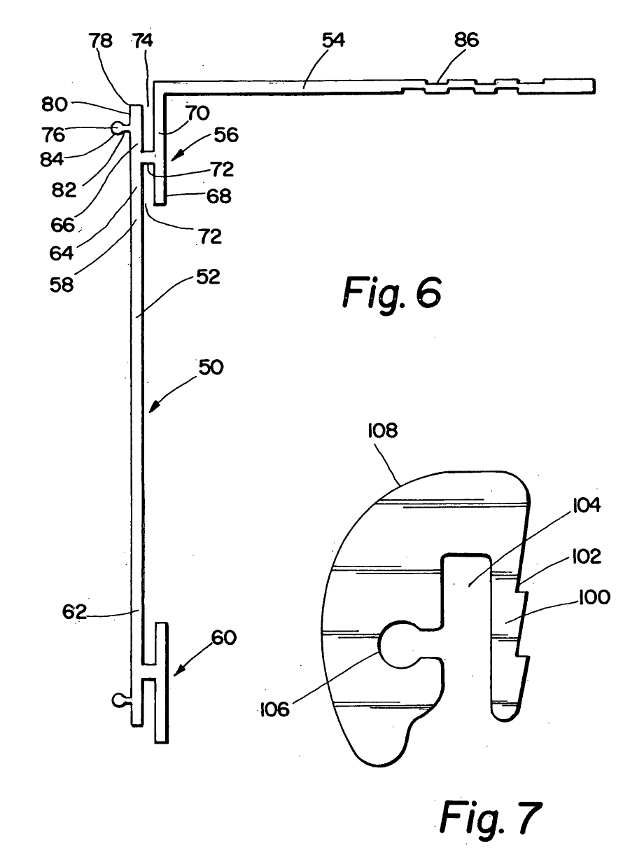

Referring now to FIG. 6, a cross-sectional view of the extrusion 50 that is utilized for the decorative valance structure 12 is illustrated. The extrusion 50 is formed from PVC material and can be cut to length for the longitudinally extending portion 30 and the return portion 32 of the decorative valance structure 12. The extrusion 50 has a configuration as shown and has an upright portion 52, a top portion 54, a first portion, shown generally by the numeral 56, joining the upright portion 52 to the top portion 54 adjacent the top 58 of the upright portion 52, and a second portion, shown generally by the numeral 60, adjacent the bottom 62 of upright portion 52. The first portion 56 and the second portion 60 are similar in structure and configuration and thus the structure and configuration of only the first portion 56 will be described. It is understood that a similar description of the second portion 60 can be made but is deleted herefrom for the sake of conciseness and brevity.

The first portion 56 of the extrusion 50 is generally H-shaped in configuration and is comprised of a first vertically extending portion 64, a second vertically extending portion 66, a third vertically extending portion 68, and a fourth vertically extending portion 70. A horizontally extending portion 72 interconnects the junction of the first vertically extending portion 64 and the second vertically extending portion 66 with the junction of the third vertically extending portion 68 and the fourth vertically extending portion 70 forming a gap 72 between the first vertically extending portion 64 and the third vertically extending portion 68 and a gap 74 between the second vertically extending portion 66 and the fourth vertically extending portion 70. A projection 76 is provided on the second vertically extending portion 66 adjacent the top 78 thereof The projection 76 is positioned so as to be directed outwardly from the surface 80 of second vertically extending portion 66 of the extrusion 50 and is comprised of a substantially horizontal portion 82 terminating in a rounded portion 84. A plurality of ridges 86 are provided in top portion 54 of extrusion 50 permitting the attachment of brackets (not shown) thereto.

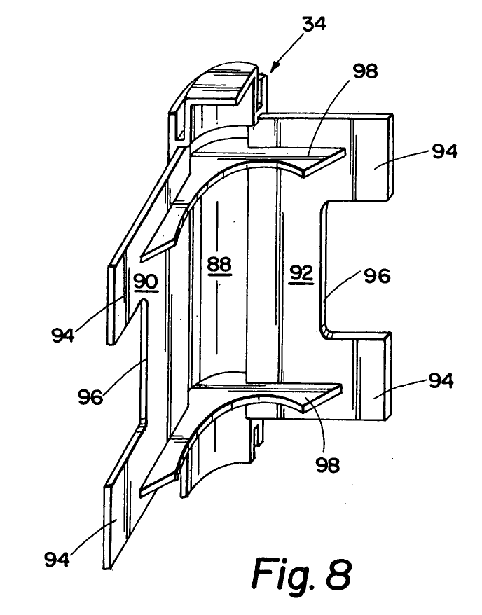

Referring now to FIG. 8, a perspective view of corner member 34 is illustrated. Corner member 34 is comprised of a central portion 88 which joins oppositely disposed end portions 90, 92. Each end portion 90, 92 is comprised of spaced-apart tab portions 94 having a recessed portion 96 therebetween. The overall height of each end portion 90, 92 approximates the overall distance between the bottom of horizontally extending portion 72 in first portion 56 of extrusion 50 and the top of a similar horizontally extending portion in the second portion 60 of extrusion 50. In addition, the thickness of each end portion 90, 92 approximates the width of gap 72 between the first vertically extending portion 64 and the third vertically extending portion 68 in first portion 56 of extrusion 50 and the width of a similar gap in second portion 60 of extrusion 50. Spaced apart strengthening ribs 98 are provided across the central portion 88 and the oppositely disposed end portions 90, 92 of corner member 34.

In order to assemble the decorative valance structure 12 of the present invention, the longitudinally extending portion 30 and the return portions 32 are cut to the desired length from the extrusion 50. The corner member 34 then joins end 36 of the longitudinally extending portion 30 to end 38 of the return portion 32 by inserting end portion 90 of corner member 34 into gap 72 in first portion 56 of extrusion 50 and into a similar gap in second portion 60 of extrusion 50 adjacent end 36 of longitudinally extending portion 30. End portion 92 of corner member 34 is then inserted into gap 72 in first portion 56 of extrusion 50 and a similar gap in second portion 60 of extrusion 50 adjacent end 38 of return portion 32 joining longitudinally extending portion 30 to return portion 32.

Referring now to FIG. 5, a partial cross-sectional view of the elongated flexible extrusion 40 that is positioned along the top and bottom of the decorative valance structure 12 is illustrated. The extrusion 40 is formed from PVC material and has a configuration complementary to the first portion 56 and the second portion 60 of extrusion 50 so as to engage same and to retain the section 20 of blind material that is placed against the outer surface of the longitudinally extending portion 30, the return portions 32 and the corner members 34 of the decorative valance structure 12. As such, the extrusion 40 has a first portion 100 having a plurality of inwardly directed spaced-apart recesses 102 on the outer surface thereof First portion 100 is sized so as to be receivable within gap 74 between second vertically extending portion 66 and fourth vertically extending portion 70 in first portion 56 of extrusion 50. In addition, the extrusion 40 has a recess 104 therein that is sized to receive the second vertically extending portion 66 in first portion 56 of extrusion 50. Extrusion 40 also has a recess 106 therein that is sized and positioned so as to receive projection 76 on second vertically extending portion 66 of extrusion 50. The outer surface 108 of extrusion 40, other than the outer surface of the first portion 100 thereof, is generally curved so as to give a decorative appearance to the extrusion 40.

A section 20 of vertical blind material that “matches” the blind material utilized for the blind members 14 is received between the surface 110 of upright portion 52 of extrusion 50 and is retained in a contacting relationship therewith by portion 112 of surface 108 of extrusion 40 which grippingly engages the top portion 114 of section 20 of vertical blind material. In this manner, the overall appearance of the valance structure 12 of the present invention is decorative and pleasing to the eye.

Certain modifications and improvements will occur to those skilled in the art upon reading the foregoing. It is understood that all such modifications and improvements have been deleted herein for the sake of conciseness and readability, but are proper within the scope of the following claims.

We claim:

1) A decorative valance for a vertical blind assembly comprising a longitudinally extending member having a first end and an oppositely disposed second end, oppositely disposed first and second return members, a first corner member joining said first end of said longitudinally extending member with an end of said first return member, a second corner member joining said second end of said longitudinally extending member with an end of said second return member, said longitudinally extending member and said first and second return members each having retaining means attached to their respective top and bottom edges, and means for attaching said longitudinally extending portion and said first and second return members to said retaining means to retain a section of vertical blind material therebetween and against the surface of said longitudinally extending portion, said first and second return members and said first and second corner members.

2) The decorative valance as defined in claim 1 wherein said retaining means attached to the respective top and bottom edges of said longitudinally extending member and said first and second return members comprises a recess adjacent said top and bottom edges of said longitudinally extending member, said first and second return members and said first and second corner members, said attaching means being received within said recess to retain said section of vertical blind material against the surface of said longitudinally extending portion, said first and second return members and said first and second corner members.

3) The decorative valance as defined in claim 1 wherein said retaining means attached to the respective top and bottom edges of said longitudinally extending member, said first and second return members comprises a projection adjacent said top and bottom edges of said longitudinally extending member and said first and second return members, said projection grippingly engaging said attaching means to retain said section of vertical blind material against the surface of said longitudinally extending portion, said first and second return members and said first and second corner members.

4) The decorative valance as defined in claim 1 wherein said retaining means attached to the respective top and bottom edges of said longitudinally extending member and said first and second return members comprises a recess and a projection adjacent said top and bottom edges of said longitudinally extending member and said first and second return members, said recess and said projection grippingly engaging said attaching means to retain said section of vertical blind material against the surface of said longitudinally extending member, said first and second return members and said first and second corner members.

5) The decorative valance as defined in claim 2 wherein said attaching means includes a flange-like portion being receivable in said recess in said longitudinally extending member and said first and second return members and grippingly engaging same.

6) The decorative valance as defined in claim 3 wherein said attaching means has a recess therein, said projection on said longitudinally extending member and said first and second return members being receivable in said recess in said attaching means.

7) The decorative valance as defined in claim 4 wherein said attaching means has a flange-like portion and an outer portion having a recess therein, said flange-like portion being receivable in said recess in said longitudinally extending member and said first and second return members, said projection on said longitudinally extending member and said first and second return members being receivable in said recess in said outer portion of said attaching means.

8) The decorative valance as defined in claim 1 wherein said longitudinally extending member and said return members are formed from an extrusion.

9) The decorative valance as defined in claim 8 wherein said extrusion is formed from polyvinyl chloride.

10) The decorative valance as defined in claim 1 wherein attaching means is formed from an extrusion.

11) The decorative valance as defined in claim 1 wherein attaching means is formed from flexible material.

12) The decorative valance as defined in claim 11 wherein said flexible material is polyvinyl chloride.
